(19) United States
(12) Patent Application Publication
(10) Pub. No.: US 2009/0212517 A1
(43) Pub. Date: Aug. 27, 2009

(54) WHEELBARROW CHUTE ATTACHMENT

(76) Inventors: Timothy Stark, Brookline, MA (US); Allan B. Williamson, E. Falmouth, MA (US)

Correspondence Address: FALKOWSKI PLLC, P.O. BOX 650, NOVI, MI, 48376-0650, US

(21) Appl. No.: 12/036,690

(22) Filed: Feb. 25, 2008

(51) Int. Cl. B62B 1/18; B65G 67/24

(52) U.S. Cl. 280/47.31; 298/7

(57) ABSTRACT

A chute apparatus with a lip, a spout, and two or more sidewalls is disclosed. When attached to a wheelbarrow, the chute apparatus rests on the rim of the wheelbarrow. Attachment to the wheelbarrow can be either permanent or temporary. A wide variety of different fasteners can be used to fasten the chute apparatus to the wheelbarrow.

### BACKGROUND OF INVENTION

The invention relates to wheelbarrows. More specifically, the invention is a chute attachment for a wheelbarrow and a method for attaching a chute attachment to a wheelbarrow (collectively the “apparatus”).

A wheelbarrow is a highly useful apparatus for transporting heavy or bulky loads. Wheelbarrows are used in a wide variety of consumer and commercial contexts. Although the specific attributes of wheelbarrow designs can vary significantly, the method of using a wheelbarrow is considerably less varied. Using a wheelbarrow typically involves loading an open container body of the wheelbarrow with whatever needs to be moved, pushing the wheelbarrow from the rear while one or more wheels supports the front end, and unloading the contents of the wheelbarrow by raising the back end of the wheelbarrow so that the contents tip vertically over the front wheel.

Depending on the shape of the wheelbarrow container and the contents of what is being moved, it can be difficult to unload the contents of a wheelbarrow in an accurate manner.

### SUMMARY OF INVENTION

The invention is a chute attachment for a wheelbarrow and a method for attaching a chute attachment to a wheelbarrow (collectively the “apparatus”). By attaching a chute attachment to a wheelbarrow, the functionality of the wheelbarrow can be enhanced.

The apparatus can be more fully understood upon reading the following drawings.

### BRIEF DESCRIPTION OF THE DRAWINGS

FIG. 1a is a structural diagram illustrating an example of a side view of a wheelbarrow.

FIG. 1b is a structural diagram illustrating an example of a top view of a wheelbarrow.

FIG. 2a is a structural diagram illustrating an example of a perspective view of a chute attachment.

FIG. 2b is a structural diagram illustrating an example of a front view of a chute attachment.

FIG. 2c is a structural diagram illustrating an example of a side view of a chute attachment.

FIG. 2d is a structural diagram illustrating an example of a top view of a chute attachment.

FIG. 3a is a structural diagram illustrating an example of a side perspective view of an assembly that includes a wheelbarrow and a chute attachment.

FIG. 3b is a structural diagram illustrating an example of a side perspective view of an assembly that includes a wheelbarrow and a chute attachment.

FIG. 3c is a structural diagram illustrating an example of a front perspective view of an assembly that includes a wheelbarrow and a chute attachment.

FIG. 3d is a structural diagram illustrating an example of a side view of an assembly that includes a wheelbarrow and a chute attachment.

FIG. 3e is a structural diagram illustrating an example of top view of an assembly that includes a wheelbarrow and a chute attachment.

FIG. 3f is a structural diagram illustrating an example of a front view of an assembly that includes a wheelbarrow and a chute attachment.

FIG. 4 is a structural diagram illustrating an example of a cross section view of the rim of a wheelbarrow and a lip of the chute attachment.

The apparatus can be more fully understood upon reading the following description in conjunction with the drawings described above.

### DETAILED DESCRIPTION

### I. Overview

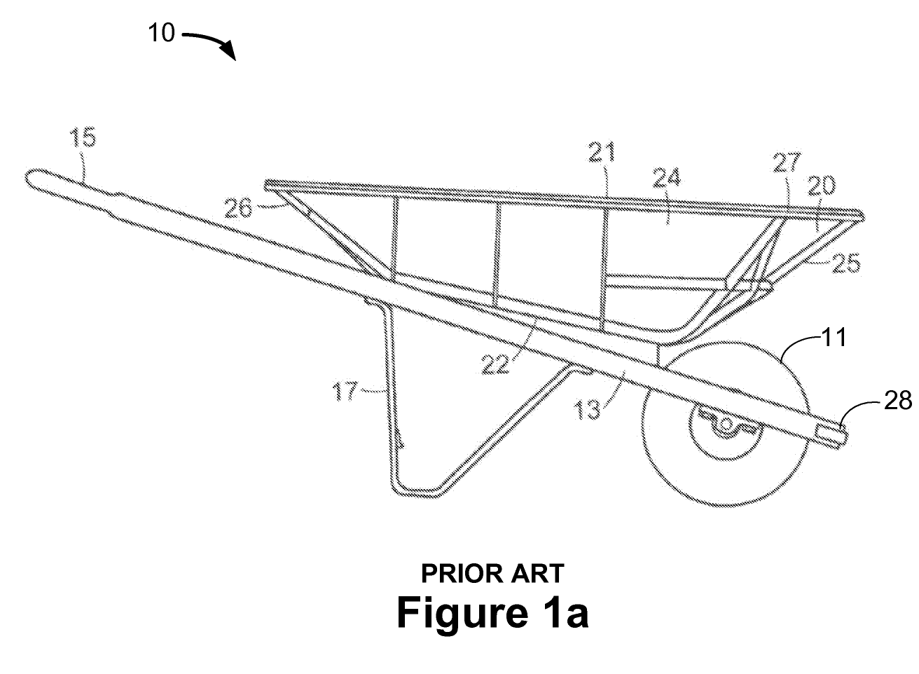

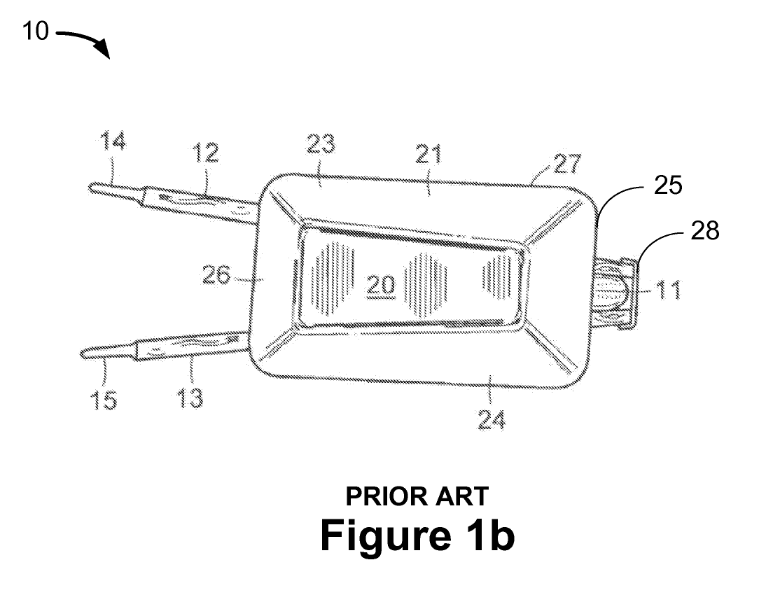

As illustrated in FIGS. 1-4, the invention is a chute attachment 30 for a wheelbarrow 10 and a method for attaching a chute attachment 30 to a wheelbarrow 10 (collectively the “apparatus”). By attaching a chute attachment 30 to a wheelbarrow 10, the functionality of the wheelbarrow 10 can be enhanced.

A wheelbarrow assembly 45 includes both the wheelbarrow 10 and the chute attachment 30. A wheelbarrow assembly 45 can include a wide variety of different wheelbarrow 10 and chute attachment 30 designs and configurations.

### II. Wheelbarrows

Wheelbarrows 10 can vary widely in terms of specific design attributes. Different embodiments of chute attachments 30 can be used to accommodate different alternative embodiments of wheelbarrows 10. FIGS. 1a and 1b illustrate two different views of a fairly typical prior art wheelbarrow 10. Many wheelbarrows 10 will have similar elements as those illustrated in FIGS. 1a and 1b even if the elements can be implemented in vastly different shapes, dimensions, materials, and configurations. Most embodiments of wheelbarrows are symmetrical with respect to the left and right sides, but the chute attachment 30 could be configured to fit a non-symmetrical wheelbarrow 10 if desired.

A. Side View

FIG. 1a is a structural diagram illustrating an example of a side view of a wheelbarrow 10. A right side handle 15 can be used in conjunction with a left side handle 14 (the left side handle 15 is not visible in the Figure) to both push the wheelbarrow 10 as well as to tip the wheelbarrow 10 in order to pour out the contents of the wheelbarrow 10.

Two rear support legs, a right rear support leg 17 and a left rear support leg 16 (the left rear support leg 17 is not visible in the Figure) can be used to place the wheelbarrow 10 in a stable resting position.

A container body 20 is the component that is used to actually hold what is loaded into the wheelbarrow 10. The container body 20 can vary widely from embodiment to embodiment. For example, different container bodies 20 can have different thicknesses, heights, widths and be made of different materials, etc. A bottom 22 of the container body is supported by the two support legs 16, 17.

The container body 20 has a top 21 that is typically open, and configured by a rim 27. In most embodiments, the top 21 of the body 20 exists in the same plane, and the wheelbarrow 10 is totally open. Alternative embodiments involving non-planar tops 21 and partially or even fully closed tops 21 are possible.

The wheelbarrow 10 in FIG. 1a includes a single wheel 11, but multiple wheel 11 configurations are possible. Connecting the handles 14, 15 to the wheel 11 are a right side frame piece 13 and a left side frame piece 12 (the left side frame piece 12 is not visible in the Figure).

The container body 20 has a right side 24 as well as a left side 23 (the left side 23 is not visible in the Figure). The container body 20 in the Figure also has a front end 25 and a rear or back end 26. With a sufficient tilting to the wheelbarrow 10 by the raising of the handles 14, 15, the front end 25 of the container body 20 is the most forward protruding portion of the entire wheelbarrow 10. When at rest, a brace 28 that holds the two side frame pieces 12, 13 together in front of the wheel 11 is the most forward protruding portion of the wheelbarrow 10.

B. Top View

FIG. 1b is a structural diagram illustrating an example of a top view of a wheelbarrow 10. FIG. 1b illustrates a traditional symmetrical design for a wheelbarrow 10. The left handle 14 and right handle 15 are both visible. The left side frame piece 12 and right side frame piece 13 are similarly both visible.

FIG. 1b also illustrates an example of a roughly rectangular container body 20 without rounded corners. The dimension of the container body front 25 are roughly equal to the container body rear 26, although in some alternative embodiments, the front 25 will be significantly more narrow than the rear 26. The shape and dimensions of the rim 27 define the container body top 21. The sides 23, 24 of the container body 20 impact the shape and dimensions of the rim 27.

C Other Views

U.S. Pat. No. 6,908,089 titled “Wheelbarrow Chute Attachment” illustrates a variety of different views of a prior art wheelbarrow design. U.S. Pat. No. 6,908,089 is hereby incorporated by reference in its entirety.

D. Design Considerations

Although there are many different potential designs and configurations for wheelbarrows 10, certain wheelbarrow 10 attributes are more likely than others to impact the corresponding chute attachment 30. For example, the shape, thickness, and material used for the rim 27 of the wheelbarrow will require a chute attachment 30 to have a compatible shape, thickness, and material composition. Attributes relating to the container body 30 can also be important, particularly in how a particular chute attachment 30 is fastened to a particular wheelbarrow 10. Many wheelbarrow 10 attributes are unlikely to impact the design and implementation of the corresponding chute attachment 30. For example, the chute attachment 30 will be totally unaffected by elements such as the wheel 11, the support legs 17, and the handles 14 and 15 in many embodiments.

### III. Chute Attachments

The chute attachment 30 can be implemented in a wide variety of different embodiments. Some alternative configurations are required to accommodate variations in the dimensions of the wheelbarrow 10. Other structural variations can be used to accommodate particular loads or particular goals of use.

A. Perspective View

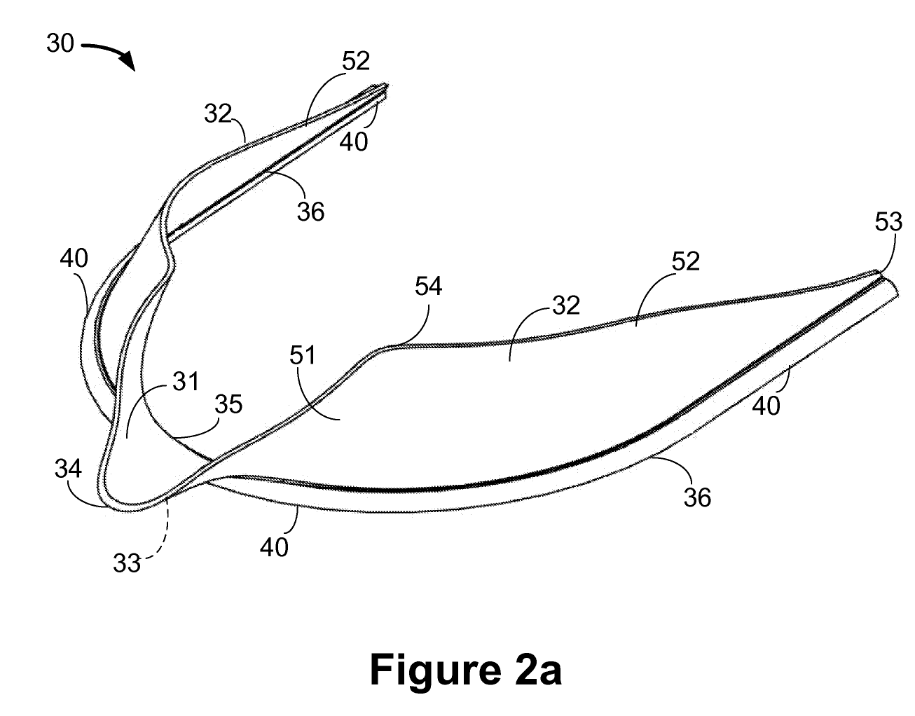

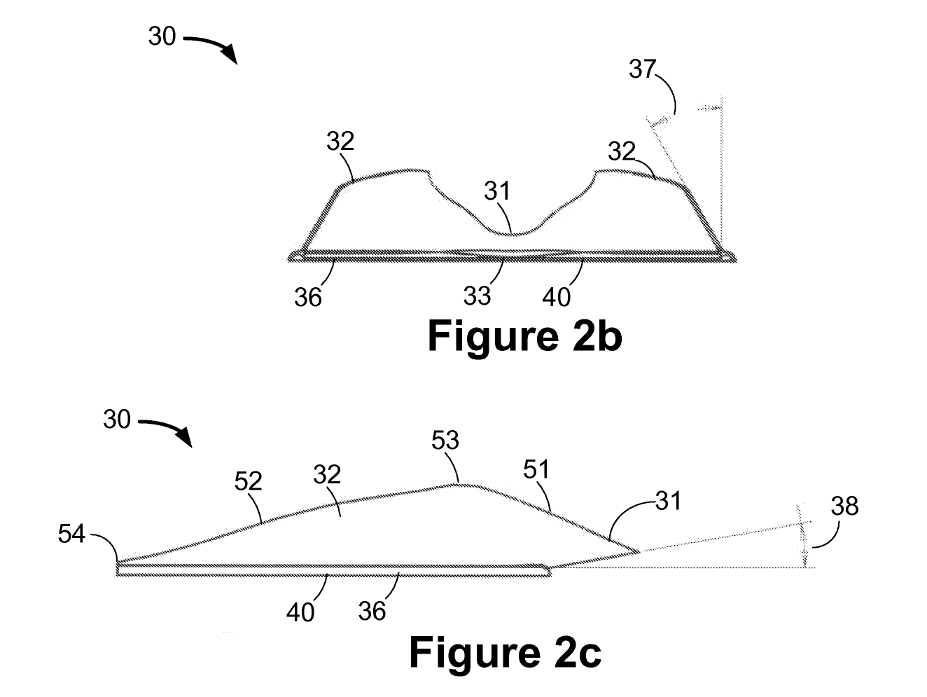

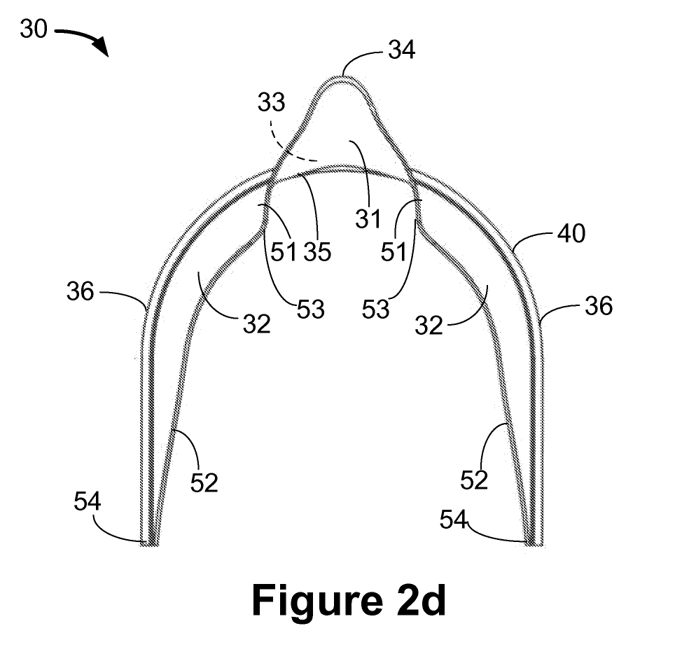

FIG. 2a is a structural diagram illustrating an example of a perspective view of a chute attachment 30. The chute attachment 30 illustrated in FIG. 2a includes a lip 40, a spout 31, and two sidewalls 32.

1. Lip

The lip 40 is the bottom portion of the chute attachment 30. The lip 40 supports the chute attachment 30 when the chute attachment is fastened or otherwise positioned on a wheelbarrow 10. The lip 40 is configured to rest on the rim 27 of the wheelbarrow 10. In many embodiments, the lip 40 does not cover the entire rim 27 and instead only rests on a portion of the total rim 27. The lip 40 can be divided into two subcomponents, the spout base or bottom 33 and the sidewall base or bottom 36.

2. Spout

The spout 31 is the portion of the chute apparatus 30 that allows users of the wheelbarrow 10 to more accurately empty the contents of the wheelbarrow 10. The chute attachment 30 can incorporate a wide variety of different spout 31 configurations relate to the shape, dimensions, and material composition of the spout 31. In most embodiments of the chute attachment 30, there is only one spout 31, but alternative embodiments involving more than one spout 31 are possible. Similarly, most embodiments of the chute attachment 30 will involve a spout 31 protruding in a forward direction, but alternative embodiments in which the spout protrudes to one of the sides or even to the rear is possible.

The spout 31 has a front end or tip 34 that protrudes further in the forward direction that any other portion of the chute attachment 30 (and further than any other portion of the wheelbarrow 10 when the chute attachment 30 is fastened to a wheelbarrow 10). The spout 31 also has a rear end 35 that is positioned above the lip 40. The spout 31 is supported by the spout bottom or base 33.

In some embodiments of the chute attachment 30, the spout 31 will protrude in a forward direction at least 5 inches beyond the spout base 33. In many embodiments, the spout 31 will be at least 5 inches wide.

3. Sidewalls

The chute apparatus 30 includes at least one sidewall 32. In many embodiments, there are two symmetrical sidewalls 32, a right sidewall 32 to the right of the spout 31 and a left sidewall 32 to the left of the spout 31. Some embodiments may possess more than two sidewalls, and it is possible for some non-symmetrical embodiments to involve an odd number of sidewalls 32.

Some sidewalls 32 such as the sidewalls in FIG. 2a can be divided into two portions, a front sidewall portion or component 51 and a rear sidewall portion or component 52. As illustrated in the Figure, the front sidewall portions 51 run from the spout to a point 53 of the sidewall's maximum height. The rear or back sidewall portions 52 run from the maximum height point 53 to a minimum height 54. Different embodiments of the chute apparatus 30 may involve vastly different sidewall dimensions. In some embodiments of the chute attachment 30, the height maximum height point 52 will not exceed approximately 5 inches.

For example, it is possible for the left sidewall 32 to touch the right sidewall 32 in some embodiments of the chute attachment 30. In some such embodiments, the sidewalls 32 constitute a partial or total cover or door which must be opened to either load or unload the wheelbarrow 10 the chute attachment 30 is fastened to the wheelbarrow 10. In such embodiments, it can be desirable for the sidewalls 32 and sometimes even the entire chute attachment 30 to be made of a material that is transparent so that the user of a wheelbarrow 10 can view the contents of the wheelbarrow despite the closed or partially closed nature of the top 21.

B. Front View

FIG. 2b is a structural diagram illustrating an example of a front view of a chute attachment 30. As discussed above, the lip 40 which serves as the base for the entire chute attachment 30 can be divided into two parts, a sidewall base 36 that underlies each sidewall 32 and a spout base 33 that supports the spout 31.

FIG. 2b also illustrates a parameter that can be important to the configuration of the chute attachment 30. A sidewall tilt angle 37 can impact the utility of the chute attachment 30. In most embodiments, the sidewalls 32 tilt in an inward direction with respect to the chute attachment 30 (and to the container body 20 when the chute attachment 30 is fastened to a wheelbarrow 10), and thus the sidewall tilt angle 37 is usually greater than or equal to zero, although in some contexts it could actually be a negative number. In typical embodiments, the sidewall tilt angle 37 will be approximately between about 0 degrees and about 30 degrees. In some contexts, the range can be between about 5 degrees and about 15 degrees, or even between approximately 8 degrees and 12 degrees can be desirable. In some embodiments, a sidewall tilt angle 37 of about 10 degrees is desirable.

C. Side View

FIG. 2c is a structural diagram illustrating an example of a side view of a chute attachment 30. FIG. 2c illustrates the right side of the spout 31 attached to a right sidewall 32. The lip 40 under the right sidewall 32 is the right sidewall base or bottom 36. The sidewall 32 can be divided into two portions, with a maximum height point 53 dividing the front sidewall portion 51 from the rear sidewall portion 52. In the illustration, the height at the maximum height point 53 of the sidewall exceeds the height of the sidewall 32 at the minimum point 54 by a factor that far exceeds 10 to 1. In the example illustrated in the Figure, the height at the maximum height point 53 is higher than the height of the spout 31 and the height of the sidewall 32 at the minimum height point 54 is lower than the height of the spout 31. The decrease in height from the maximum point 53 to the minimum point 54 is continuous or substantially continuous in the Figure. Different configurations involving different shapes and dimensions can be incorporated into chute attachment 30.

Also illustrated in the Figure is a spout flatbed angle 38. The chute attachment 30 can incorporate a wide variety of different flatbed angles 38. The higher the angle 38, the less likely accidental spills are to occur, but the greater the difficulty a user will have in pouring out the contents of the wheelbarrow 10. The lower the angle 38, the easier it is to remove the contents from the container body 20 of the wheelbarrow 10, but the greater the likelihood of accidental spillage. The flatbed angle 38 will typically range from about 0 degrees to about 90 degrees. In many embodiments, a range between about 20 degrees to about 40 degrees can be used. In some embodiments, a flatbed angle 38 of approximately 30 degrees can be used.

D. Top View

FIG. 2d is a structural diagram illustrating an example of a top view of a chute attachment 30. FIG. 2d illustrates an example of a symmetrical chute attachment 30 with a right sidewall 32 and a left sidewall 32. Each sidewall 32 includes a front portion 51 that is adjacent to the spout 31 and a rear portion 52. A maximum height point 53 divides the front portion 51 from the rear portion.52. FIG. 2d illustrates that that the spout 31 has a front tip 34 that protrudes further in a forward direction than any other part of the chute attachment 30 and a spout rear end 35 that is no further forward than the part of the lip 40 (the spout base 33) upon which the spout 31 rests.

E. Additional Attributes

The chute attachment 30 can be made up of a wide variety of different materials. The desirable material composition of the chute attachment 30 can be impacted by the specific design attributes of the wheelbarrow 10 and to the nature of the materials being loaded onto and unloaded from the wheelbarrow. In many contexts, it can be desirable for the chute attachment 30 to include a thermal polyethylene plastic. In other embodiments, the chute can be thermoformed, injection molded, rotation molded, pressure formed or molded, or assembled of other plastics, wood, metals, cardboard, fiberglass, and other types of substances . . . . The chute attachment 30 can potentially be made of any material capable of maintaining structural rigidity when stressed by the loading and unloading of the contents of the wheelbarrow 10.

In some embodiments, the chute attachment 30 is manufactured as a single piece, and thus the spout 31, lip 40, and sidewalls 32 cannot be separated from each other. In other embodiments, the chute attachment 30 is machined or otherwise configured to allow the attachment 30 to be disassembled and then subsequently reassembled.

The purpose of the chute attachment 30 is to be fastened to a wheelbarrow 10 in order to enhance the utility of the wheelbarrow 10. In some embodiments, the chute attachment 30 is configured to only temporarily be fastened to the wheelbarrow, i.e. it is fastened on a non-permanent basis and may subsequently be unfastened and detached at a later point in time. In other embodiments, the fastening of the chute attachment 30 to a wheelbarrow 10 is permanent or substantially permanent. In still other embodiments, the wheelbarrow 10 is machined or otherwise manufactured with a chute attachment 30 fastened to the wheelbarrow 10.

### IV. Assemblies

A combination of a wheelbarrow 10 with an attached chute attachment 30 can be referred collectively as a wheelbarrow assembly 45 or simply an assembly 45.

A. Different Perspective Views

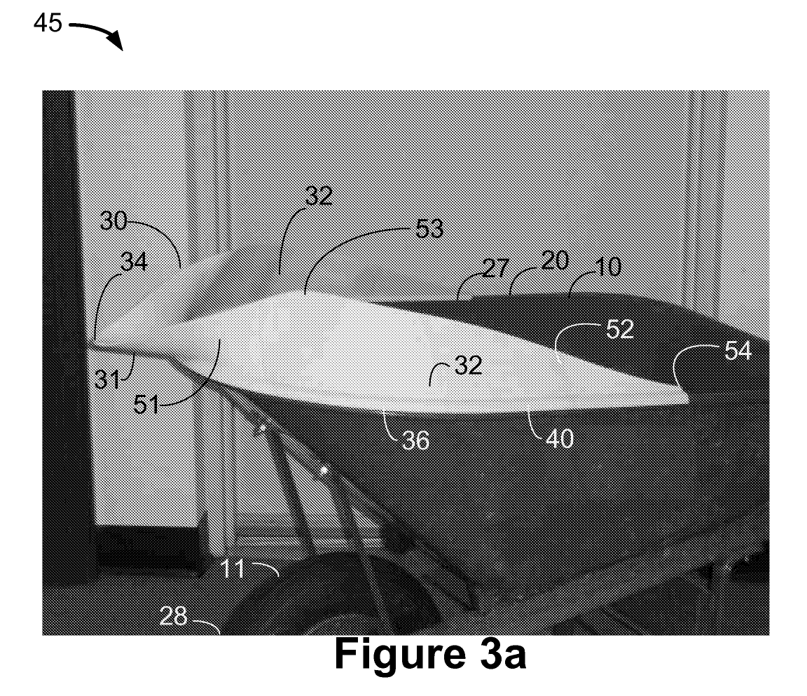

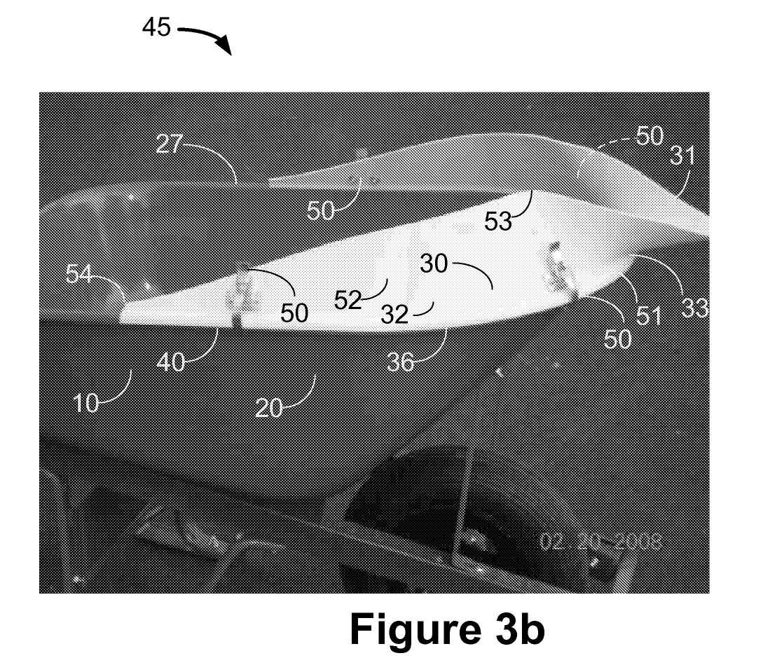

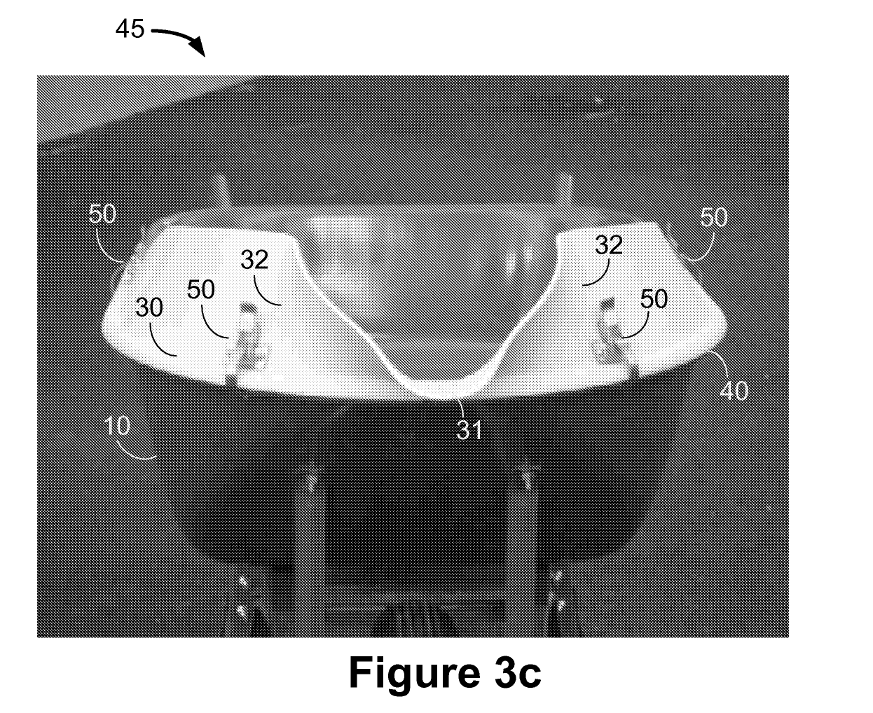

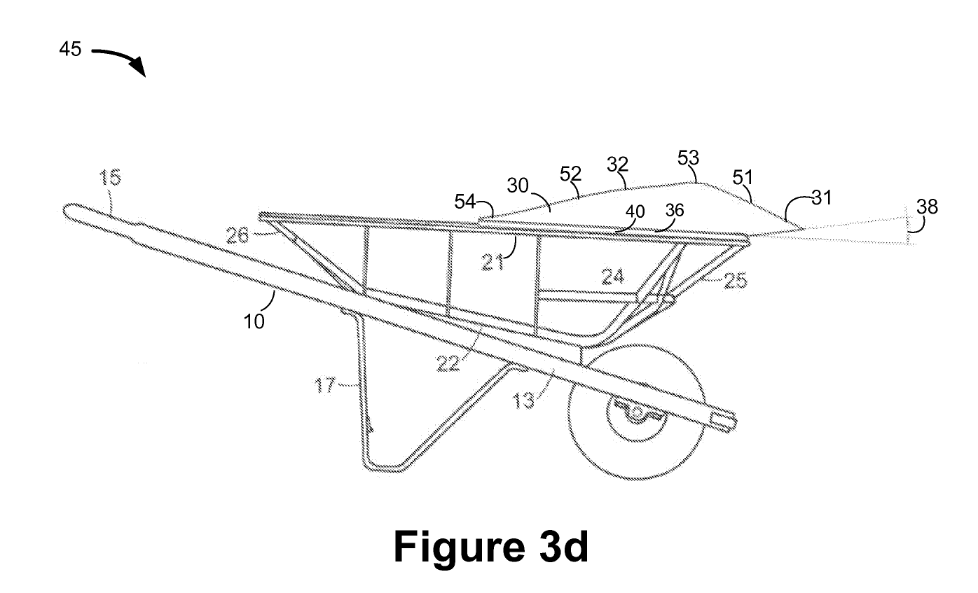

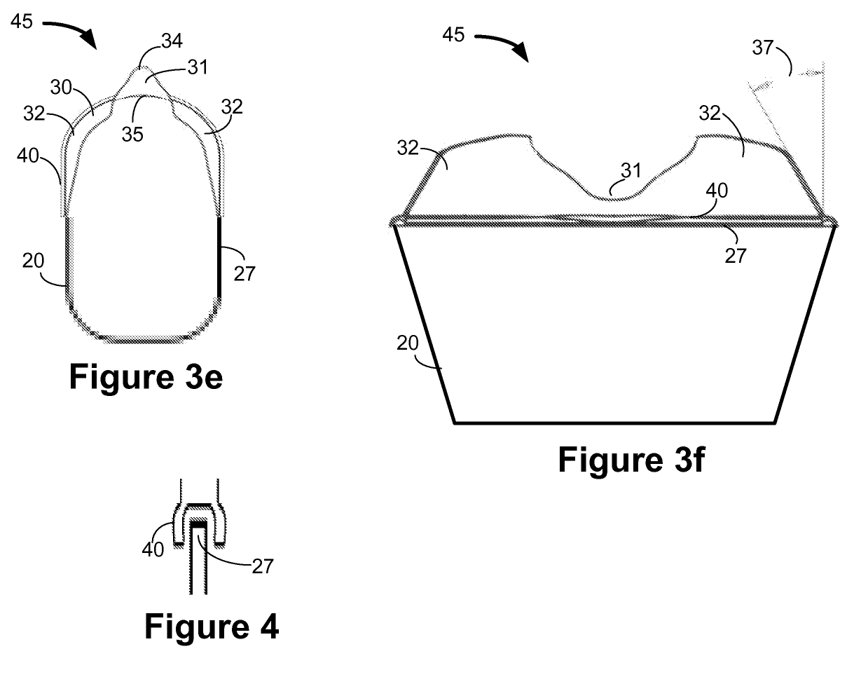

FIG. 3a is a structural diagram illustrating an example of a side perspective view of an assembly 45 that includes a wheelbarrow 10 and a chute attachment 30. In the example of FIG. 3a, the lip 40 of the chute attachment 30 does not cover the entire rim 27 of the wheelbarrow 10. In the example of FIG. 3a, the tip 34 of the spout 31 occupies a forward position that is in front of the wheel 11 and the brace 28.

FIG. 3b is a structural diagram illustrating an example of a side perspective view of an assembly 45 that includes a wheelbarrow and a chute attachment 30. FIG. 3b illustrates an example of fasteners 50 that can be used to fasten (e.g. secure) the chute attachment 30 to the wheelbarrow 10. The type of fastener 50 illustrated in the Figure is a clamp, but as discussed below, a wide variety of different fasteners 50 can be used.

FIG. 3c is a structural diagram illustrating an example of a front perspective view of an assembly 45 that includes a wheelbarrow 10 and a chute attachment 30. Four fasteners 50 are visible in the Figure. FIG. 3c also illustrates an example of the relative size and shape of the chute apparatus 30 with the respect to the top 21 of the wheelbarrow 10. Different embodiments of the assembly 45 may close off either more or less area from the otherwise open wheelbarrow 10. As discussed above, in some embodiments, the right and left sidewalls 32 can be sufficiently large to be in partial or even total contact with each other, effectively placing a partial or total “door” over the wheelbarrow 10. In such embodiments, the chute attachment 30 can be configured with a mechanism to support the opening and closing of the attachment 30 so that the corresponding wheelbarrow 10 can be loaded and unloaded.

B. Side View

FIG. 3d is a structural diagram illustrating an example of a side view of an assembly 45 that includes a wheelbarrow 10 and a chute attachment 30. FIG. 3d includes an illustration of the spout flatbed angle 38 in the context of the rim 27 and other wheelbarrow 10 components.

C. Top View.

FIG. 3e is a structural diagram illustrating an example of top view of an assembly 45 that includes a wheelbarrow 10 and a chute attachment 30. As illustrated in the Figure, the lip 40 covers only a portion of the rim 27 of the wheelbarrow 10 and the tip 34 of the spout 31 protrudes in a forward position that is in front of the front-most portion of the lip 40 and the rim 27.

D. Front View

FIG. 3f is a structural diagram illustrating an example of a front view of an assembly 45 that includes a wheelbarrow 10 and a chute attachment 30. The Figure includes an illustration of the sidewall tilt angle 37, which as discussed above is usually equal to or greater than about 0 degrees.

### V. Fasteners

FIG. 4 is a structural diagram illustrating an example of a cross section view of the rim 27 of a wheelbarrow 10 and a lip 40 of the chute attachment 30. In some embodiments of the assembly 45, no fastener 50 is requirement because the lip 40 of the chute attachment 30 is designed to mate with the rim 27 of the wheelbarrow in a sufficiently fastened manner that no additional restraints are required. In other embodiments, a wide variety of different fasteners 50 and/or configurations of fasteners 50 can be used. Examples of fasteners 50 can include clamps, straps, cords, bolts, adhesives, screws, ropes, bungee cords, clasps, snaps, buttons, and zippers.

### VI. Method of Fastening

In some embodiments, the chute attachment 30 is attached to the wheelbarrow 10 during the fabrication of the wheelbarrow 10. In other embodiments, the chute attachment 30 is permanently attached to the wheelbarrow 10, but such fastening does not occur in the manufacturing process of the wheelbarrow 10.

In many embodiments, the chute attachment 30 is not permanently attached to the wheelbarrow 10. Instead, the chute attachment 30 is fastened when it is useful for the user, and removed when that utility has temporarily ended.

In such embodiments, the lip 40 of the chute attachment 30 is placed on top of the a front portion 25 of the rim 27 so that the spout 31 and the sidewalls 31 of the chute attachment 30 are positioned above the rim 27 and thus rest on top of the wheelbarrow 10. In some embodiments, there is no fastener 50 required to restrain the chute attachment 30 on the wheelbarrow because the lip 40 of the chute attachment 30 is adapted to mate with the rim 27 of the wheelbarrow 10. In other embodiments, fasteners 50 such as those described above are used to secure the assembly 45. In many fastener 50 embodiments of the assembly 45, clamps are used as the fastener 50, so the user can use the clamps to secure the position of the chute attachment 30 on the wheelbarrow 10.

### VII. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. A chute attachment configured for attachment to a wheelbarrow, wherein the wheelbarrow has a top rim and a front end, said chute attachment comprising:
a lip, wherein said lip provides for fastening to the top rim of the wheelbarrow, and wherein said lip includes a spout base and sidewall base;
a spout, wherein said spout is positioned above said spout base when said lip is fastened to the top rim of the wheelbarrow; and
a plurality of sidewalls, wherein said plurality of sidewalls are positioned above said sidewall base when said lip is fastened to the top rim of the wheelbarrow.

2. The chute attachment of claim 1, said plurality of sidewalls including a first sidewall and a second sidewall, wherein said sidewalls tilt in an inward direction, wherein said first sidewall does not touch such second sidewall, wherein both said sidewalls touch said spout, and wherein spout protrudes in an outward direction such that an outermost tip of the spout exceeds the front end of the wheelbarrow.

3. The chute attachment of claim 1, wherein said lip provides for being fastened to the top rim of the wheelbarrow with at least one of: (a) a clamp; (b) a strap; (c) a cord; (d) a bolt; (e) an adhesive; (f) a screw; (g) a rope; (h) a bungee cord; (i) a clasp; (j) a snap: (k) a zipper; or (l) a button, and wherein said chute apparatus is comprised of a plastic material.

4. The chute attachment of claim 3, wherein said lip provides for being fastened to the top rim of the wheelbarrow with a plurality of clamps, and wherein said chute apparatus is comprised of a thermal polyethylene plastic.

5. The chute attachment of claim 1, wherein said sidewalls tilt inwards at an angle between approximately 0 and 30 degrees.

6. The chute attachment of claim 2, wherein said sidewalls tilt inwards at an angle between approximately 8 and 12 degrees.

7. The chute attachment of claim 1, wherein said lip does not cover the entire top rim of the wheelbarrow when the lip is fastened to the top rim of the wheelbarrow.

8. The chute attachment of claim 7, wherein each sidewall in said plurality of sidewalls includes a front sidewall portion and a rear sidewall portion, wherein said front sidewall portion touches said spout, wherein said rear sidewall does not touch said spout, and wherein a rear end of said rear sidewall portion is lower in height than a top of said spout.

9. The chute attachment of claim 8, said rear sidewall portion including a plurality of heights, said plurality of heights including a first height closest to said front sidewall portion and a second height furthest from said front sidewall portion, wherein said first height is at least 10 times said second height.

10. The chute attachment of claim 8, wherein the reduction in magnitude from said first height to said second height is substantially continuous.

11. The chute attachment of claim 8, wherein said first height is taller than said spout.

12. The chute attachment of claim 1, wherein said lip, said sidewalls, and said spout are not configured to be separable from said chute attachment.

13. The chute attachment of claim 1, wherein said lip is adapted to be detached from the top rim of the wheelbarrow after being previously fastened to the wheelbarrow.

14. A detachable chute attachment configured for attachment to the top of a wheelbarrow, wherein the wheelbarrow has a top rim and a front end, said chute attachment comprising:
a bottom lip, wherein said lip provides for fastening to the top rim of the wheelbarrow, wherein said lower lip includes a spout base and sidewall base, wherein said lip does not cover the entire top rim of the wheelbarrow when said lip is fastened to the top rim of the wheelbarrow, wherein said bottom lip includes a plurality of fasteners including at least one of: (a) a clamp; (b) a bolt; (c) a cord; (d) a strap; and (e) a screw;
a spout connected on top of the spout base, wherein said spout is positioned above said spout base when said lip is fastened to the top rim of the wheelbarrow, wherein said spout protrudes outward from the wheelbarrow in a forward direction;
a plurality of sidewalls, said plurality of sidewalls including a first sidewall and a second sidewall, wherein said plurality of sidewalls are positioned above said sidewall base when said lip is fastened to the top rim of the wheelbarrow, and wherein said plurality of sidewalls tilt in an inwards direction.

15. The detachable chute attachment of claim 14, wherein the said plurality of sidewalls tilt at an angle approximately between 5 and 15 degrees.

16. The detachable chute attachment of claim 14, wherein said detachable chute attachment is machined as a single piece of thermal polyethylene plastic.

17. The detachable chute attachment of claim 14, wherein fasteners include a plurality of clamps.

18. The detachable chute attachment of claim 14, wherein said spout has a flatbed angle of about 30 degrees.

19. The detachable chute attachment of claim 14, wherein said spout protrudes in a forward direction at least 5 inches beyond said spout base, wherein said spout has a width that is at least 5 inches wide, wherein the height of said sidewalls does not exceed 5 inches, and wherein said first sidewall does not touch said second sidewall.

20. A method of fastening a chute attachment to a wheelbarrow, comprising:
placing a lip of the chute attachment on top of a front portion of a rim of the wheelbarrow so that a spout and a plurality of sidewalls on the chute attachment are positioned above the height of the rim of the wheelbarrow;
fastening the chute attachment to the top of the front portion of the rim of the wheelbarrow by tightening a plurality of clamps attached the chute attachment.
